(19) United States
(12) Patent Application Publication
(10) Pub. No.: US 2011/0091263 A1
(43) Pub. Date: Apr. 21, 2011

(54) NAIL POLISH APPLICATOR HAVING ILLUMINATION MEANS

(76) Inventors: Justin A. von Eberstein, Henderson, NV (US); Kelly G. Vaughn, Henderson, NV (US)

(21) Appl. No.: 12/539,441

(22) Filed: Aug. 11, 2009

Related U.S. Application Data
(60) Provisional application No. 61/087,999, filed on Aug. 11, 2008.

(51) Int. Cl. A46B 11/00; A45D 29/00; B43K 29/00

(52) U.S. Cl. 401/129; 132/73; 401/195

(57) ABSTRACT

A nail polish applicator having illumination means. A main body of the nail polish applicator supports a brush holder and brush. The main body houses a power source, one or more light devices arranged on a printed circuit board housed by said main body to direct light to the brush and activation means configured to illuminate the light devices. The light devices may be conventional or focused light emitting diodes. Three light emitting diodes may be evenly spaced about the printed circuit board housed in the main body and activated by an automatic or manual switch.

### CROSS-REFERENCE

This application claims the benefit of U.S. Provisional Application No. 61/087,999 filed Aug. 11, 2008.

### FIELD OF THE INVENTION

The embodiments of the present invention relate to a nail polish applicator having illumination means for lighting a fingernail area during the application of nail polish.

### BACKGROUND

Cosmetics are a multi-billion dollar industry with nail polish sales contributing significantly to the sales figures. Despite the tremendous sales volume for nail polish, the method of applying fingernail polish has remained substantially unchanged since its inception. Typically, nail polish is applied using a brush attached to an applicator. While this configuration is suitable, improvements are possible to improve the quality of applied nail polish.

Thus, there continues to be a need for an improved nail polish applicator which advantageously improves a user's ability to apply nail polish in low light environments.

### SUMMARY

Accordingly, a first embodiment of the present invention is a nail polish applicator having one or more light devices configured to illuminate a fingernail during the nail polish application process. In one embodiment, three light devices are evenly spaced on a printed circuit board housed in a main body of a nail polish applicator and directed at the applicator brush and fingernail. Different techniques, including switches and buttons, for activating the light devices are disclosed.

Other variations, embodiments and features of the present invention will become evident from the following detailed description, drawings and claims.

### BRIEF DESCRIPTION OF THE DRAWINGS

FIG. 1 illustrates a perspective view of a nail polish applicator and bottle in a closed position according to a first embodiment of the present invention;

FIG. 2 illustrates a cross-sectional view along A of the nail polish applicator and bottle as shown in FIG. 1;

FIG. 3 illustrates an exploded perspective view of the nail polish applicator and bottle according to the first embodiment of the present invention;

FIG. 4 illustrates a perspective view of the nail polish applicator and bottle in an open position according to the first embodiment of the present invention;

FIG. 5 illustrates a bottom view of the nail polish applicator according to the first embodiment of the present invention;

FIG. 6 illustrates a cross-sectional view of a nail polish applicator according to a second embodiment of the present invention; and

FIG. 7 illustrates an exploded perspective view of a nail polish applicator according to the second embodiment of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

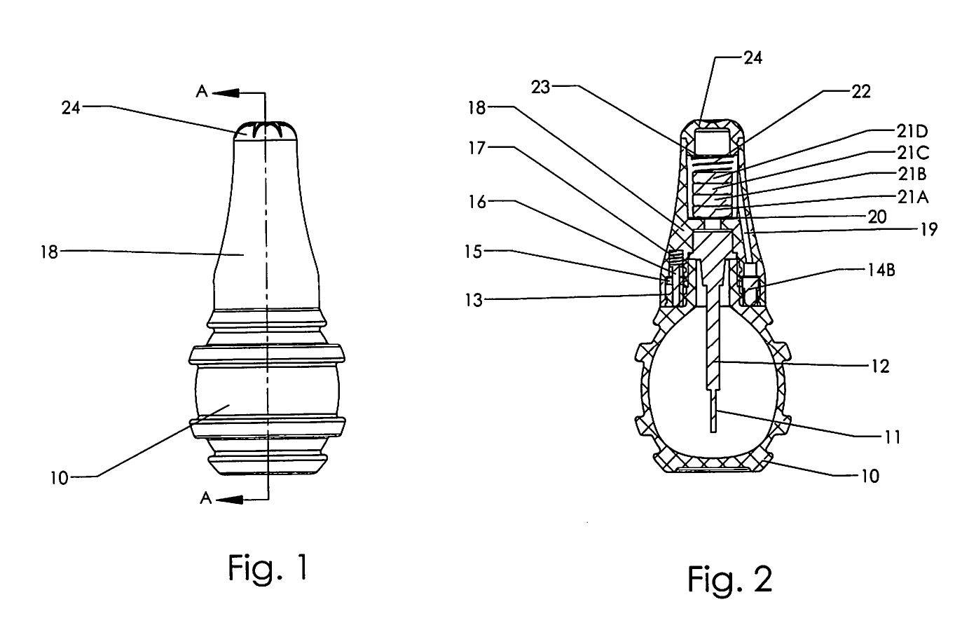

FIG. 1 shows a perspective view of a nail polish container including a nail polish applicator 18 and bottle 10 in a closed position. The nail polish applicator 18 includes a cap 24 which may be a separate piece or integral with the nail polish applicator 18. Removal of the cap 24 allows access to housed electrical components. While the nail polish applicator 18 is shown having an elongated tapered configuration and the bottle 10 is shown having a bulbous configuration, those skilled in the art will recognize that the nail polish applicator 18 and bottle 10 may take on any shape, form and size suitable to apply and hold nail polish.

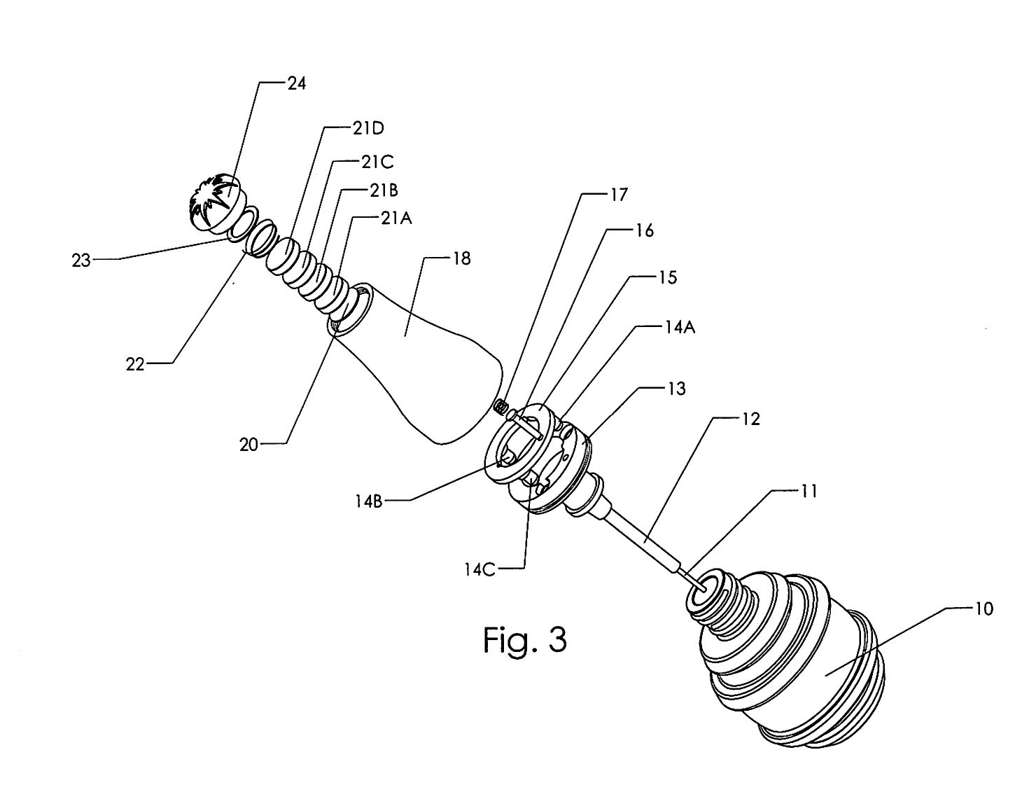

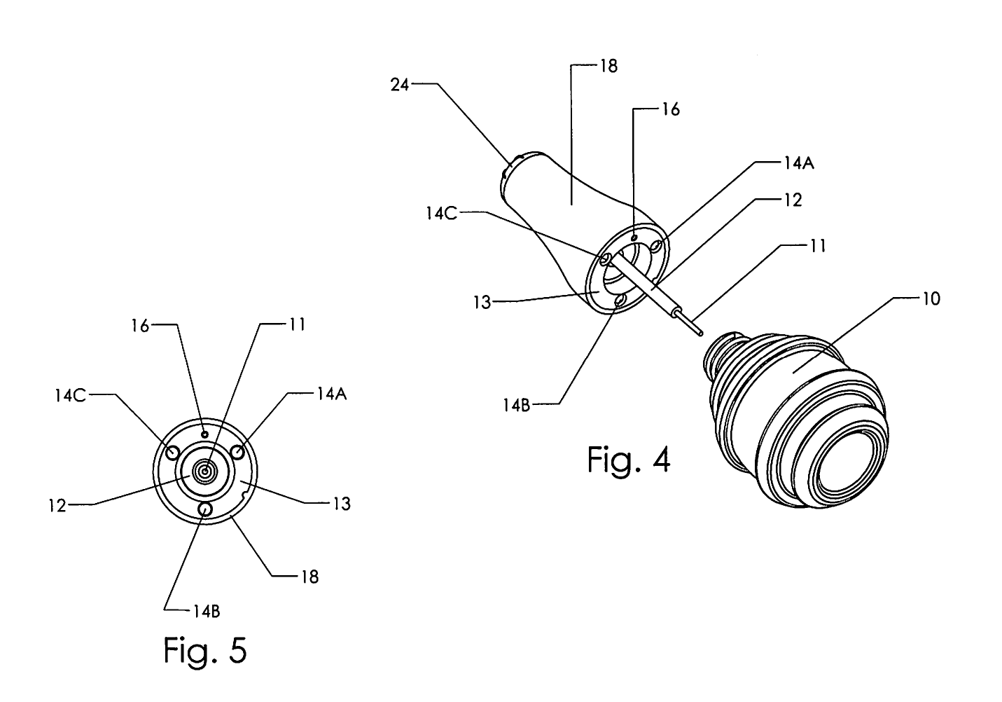

FIGS. 2 and 3 show cross-sectional and exploded views, respectively, of the nail polish applicator 18 and bottle 10. FIG. 4 shows a perspective view of the nail polish applicator 18 and bottle 10 separated. The nail polish applicator 18 has a main body having a conventional brush holder 12 extending therefrom wherein the brush holder 12 retains nail polish brush 11. The active electronic components which facilitate the embodiments of the present invention reside within internal cavities housed within the main body of the nail polish applicator 18 and enclosed with cap 24.

In one embodiment, three light emitting devices 14A, 14B and 14C are spaced evenly (i.e., 120 degrees apart) about and connected to a printed circuit board (PCB) 15. A PCB cover 13 protects the PCB 15 and includes openings through which LEDs 14A, 14B and 14C insert. In one embodiment, the LEDs are white and conventional in nature. In another embodiment, the LEDs may be focused slightly inward towards the brush 11 to enhance the effects of the light. In other embodiments, more or less than three LEDs may be used. In other embodiments, different light devices, including mini CFLs, OLEDs and mini halogen lamps, may be used in place of the LEDs.

Activation of the LEDs 14A, 14B and 14C is controlled by the configuration of switch 16, switch spring 17 and PCB 15. Switch spring 17 is compressed by the switch 16 when the nail polish applicator 18 is screwed in place on the bottle 10 and the upper disc of the switch 16 is not in contact with the PCB 15 such that the LEDs 14A, 14B and 14C are not illuminated. In other words, the light circuit is open. The upper surface of the bottle 10 adjacent to the threaded protrusion maintains the switch 16 fully contained within the nail polish applicator 18 when the nail polish applicator 18 is screwed closed. When the nail polish applicator 18 is unscrewed from the bottle 10, the switch spring 17 expands and pushes the switch 16 downward causing the upper disc of the switch 16 to make contact with the PCB 15 thereby closing the light circuit. In this position, a lower portion of the switch 16 extends below and out of the bottom surface of the nail polish applicator 18. With the light circuit closed, power from the batteries 21A, 21B, 21C and 21D is transmitted to the LEDs 14A, 14B and 14C via wires (not shown) connected to a bottom contact plate 20 and top contact plate 23 though wire passages 19. The bottom contact plate 20 and top contact plate 23 sandwich batteries 21A-21D and the LEDs 14A, 14B and 14C.

In another embodiment, a manually operated switch or button on the nail polish applicator 18 allows a user to activate the LEDs 14A, 14B and 14C when desired. The switch or button operate to close and open the circuit in the same or similar manner as the automated configuration described above.

The batteries 21A-21D, as shown, are button cell, silver button cell, coin cell or similar types stacked on top of one another. The batteries 21A-21D are sandwiched between a bottom contact plate 20 and top contact plate 23. A battery spring 22 is positioned above the top contact plate 23 to maintain the batteries 21A-21D in firm contact with one another. Those skilled in the art will recognize that other battery types may be used. It is conceivable that the nail polish container may be powered by one or more rechargeable batteries such that the a power cord is insertable at a first end into the nail polish container and a second end into an electrical outlet thereby charging the rechargeable batteries.

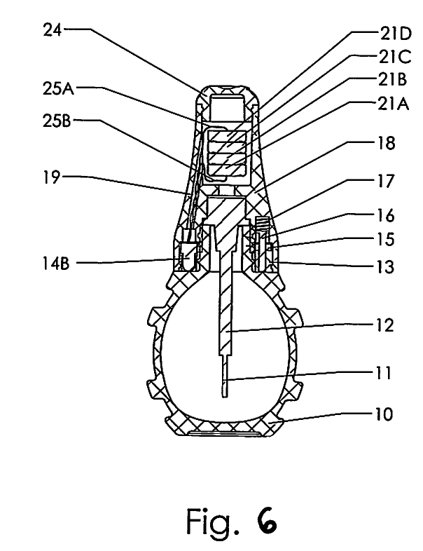

Now referring to FIG. 5, in one embodiment, the LEDs 14A, 14B and 14C are spaced evenly 120 degrees around the PCB 15 and through the PCB cover 13. This configuration provides an even light pattern at the area of the brush 11 thereby lighting the fingernail and brush 11 contact point. Focused LEDs can further focus the light on the contact point. Those skilled in the art will understand that additional LEDs may be used and spaced evenly (e.g., 4 LEDs spaced 90 degrees). Less than three LEDs may be used as well (e.g., 2 LEDs spaced 180 degrees). FIG. 5 also shows the switch 16 extending from the nail polish applicator 18.

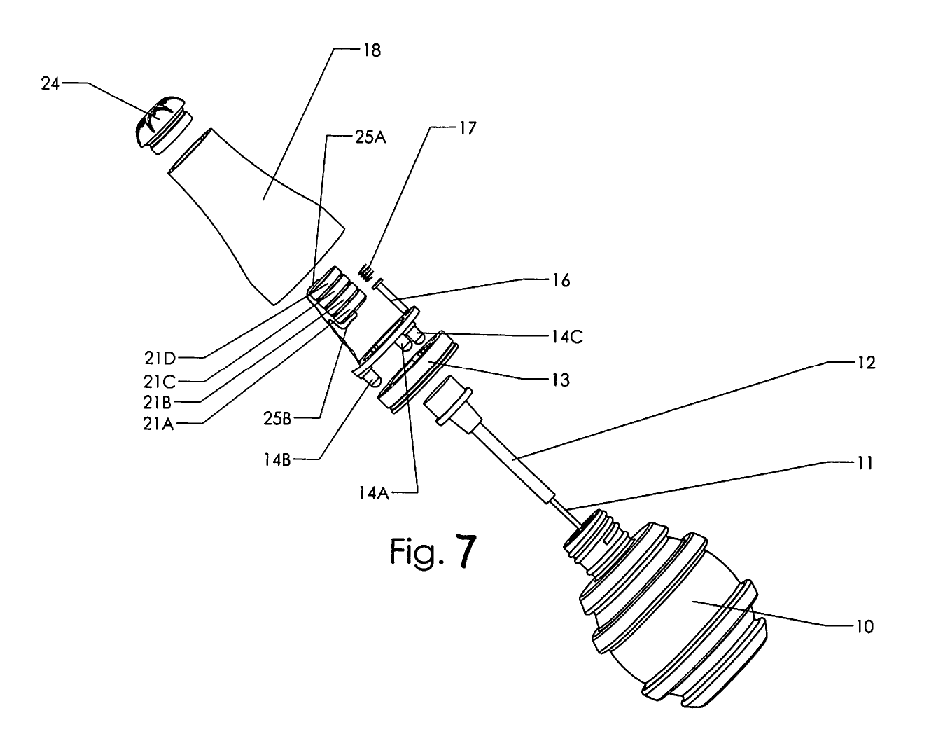

FIGS. 6 and 7 show an alternative configuration wherein the batteries 21A-21D are directly wired to the LEDs 14A, 14B and 14C. In this embodiment, the bottom contact plate 20, top contact plate 22 and battery spring 23 are not necessary. A first positive wire 25A and second negative wire 25B lead to each of the LEDs 14A, 14B and 14C through wire passage 19 thus transmitting the necessary power.

The main body, including the electrical component cavities, of the nail polish applicator 18 may be formed using injection molding, machining or other fabrication methods. The elements described herein may be made of any suitable materials including plastics, composites, alloys and the like.

Although the invention has been described in detail with reference to several embodiments, additional variations and modifications exist within the scope and spirit of the invention as described and defined in the following claims.

I claim:

1. A nail polish applicator comprising:
a main body;
a brush holder extending from said main body;
a brush extending from said brush holder;
a power source housed by said main body;
one or more light devices arranged to direct light to said brush, said light devices housed by said main body; and
activation means configured to illuminate said light devices.

2. The nail polish applicator of claim 1 wherein the activation means comprises a switch and spring combination.

3. The nail polish applicator of claim 2 wherein said switch and spring combination operate automatically.

4. The nail polish applicator of claim 1 wherein said light devices are focused light emitting diodes.

5. The nail polish applicator of claim 1 wherein the activation means comprises a manually operated switch or button on said main body.

6. The nail polish applicator of claim 1 wherein said main body is configured for attachment to a nail polish bottle.

7. A nail polish applicator comprising:
a main body;
a brush holder retaining a brush, said brush holder extending from said main body;
a power source hosed by said main body;
said main body housing one or more light devices arranged to direct light to said brush; and
a switch configured to automatically illuminate said light devices responsive to said main body being removed from a nail polish bottle and deactivate said light devices responsive to being attached to a nail polish bottle.

8. The nail polish applicator of claim 7 wherein said light devices are focused light emitting diodes.

9. The nail polish applicator of claim 7 wherein said main body is configured for attachment to a nail polish bottle.

10. A nail polish applicator comprising:
a main body;
a brush holder retaining a brush, said brush holder extending from said main body;
a power source housed by said main body;
said main body housing a printed circuit board to which three light emitting diodes are arranged to direct light to said brush, said light emitting diodes spaced 120 degrees on said printed circuit board; and
activation means configured to illuminate said light emitting diodes.

11. The nail polish applicator of claim 10 wherein the activation means comprises a switch and spring combination.

12. The nail polish applicator of claim 11 wherein said switch and spring combination operate automatically to illuminate said light devices responsive to said main body being removed from a nail polish bottle and deactivate said light devices responsive to being attached to a nail polish bottle.

13. The nail polish applicator of claim 10 wherein said light emitting diodes are focused.

14. The nail polish applicator of claim 10 wherein the activation means comprises a manually operated switch or button on said main body.

15. The nail polish applicator of claim 10 wherein said main body is configured for attachment to a nail polish bottle.
